(19) United States
(12) Patent Application Publication
(10) Pub. No.: US 2014/0174159 A1
(43) Pub. Date: Jun. 26, 2014

(54) PRESSURE-RESISTANT-CONTAINER GAS LEAKAGE DETECTING DEVICE FOR A VEHICLE TO WHICH A DISCHARGE TUBE CASING IS ATTACHED

(71) Applicant: Hack Sung Kim, Siheung-si (KR)

(72) Inventor: Hack Sung Kim, Siheung-si (KR)

(21) Appl. No.: 14/235,183

(22) PCT Filed: Jul. 23, 2012
(86) PCT No.: PCT/KR2012/005843

§ 371 Date: Jan. 27, 2014

(30) Foreign Application Priority Data
Aug. 5, 2011 (KR) 10-2011-0077995

(51) Int. Cl. G01M 3/32

(52) U.S. Cl. CPC G01M 3/32
USPC 73/49.3

(57) ABSTRACT

A pressure-resistant-container gas leakage detecting device for a vehicle, to which a discharge tube casing is attached, includes: a casing having a first casing member and a second casing member coupled to the first casing member to form an internal space; a pressure-resistant container having a body coupled to the interior of the casing and a discharge tube exposed to the outside of the casing, the discharge tube adapted to introduce gas thereinto and to discharge gas therefrom; the discharge tube casing adapted to cover the discharge tube; a first gas leakage detecting sensor attached to the discharge tube casing; corrosion-preventing gas injected between the pressure-resistant container and the casing to be filled thereinto higher or lower than atmospheric pressure; and a gas pressure detecting sensor coupled to the casing to detect the occurrence of the change in the pressure of the corrosion-preventing gas.

### BACKGROUND OF THE INVENTION

1. Field of the Invention

The present invention relates to a pressure-resistant container gas leakage detecting device for a vehicle, to which a discharge tube casing is coupled, and more particularly, to a pressure-resistant container gas leakage detecting device for a vehicle, to which a discharge tube casing is coupled, wherein even if a small amount of gas leaks, the gas leakage is early detected to basically prevent the occurrence of explosion accidents caused by the gas leakage.

2. Background of the Related Art

The number of compressed natural gas (CNG) buses (hereinafter, referred to as “gas vehicle”) has been increased so as to provide eco-friendly cities. The most important problem in such gas vehicles is whether stability exists or not. Recently, a pressure-resistant container mounted on the gas vehicle is exploded during the driving of the gas vehicle to cause many personal injuries.

The pressure-resistant container is attached to the top and underside of the gas vehicle, respectively. The underside of the vehicle is generally exposed to the foreign matters or chemical materials on the roads or to rain water, and accordingly, the pressure-resistant container attached to the underside of the gas vehicle may be easily corroded. Thus, the pressure-resistant container is periodically checked in accordance with the driving of the vehicle, but it is not easy to frequently check whether the pressure-resistant container is corroded or safe.

Particularly, in case where a temperature is high in summer, the pressure-resistant container has low stability due to high internal pressure thereof.

The gas leaking from the pressure-resistant container is exploded when contacted with a flammable material, thus causing personal injuries. Further, the pressure-resistant container may be exploded due to high internal pressure thereof. Therefore, there is a definite need for the development of a new safety device that prevents the explosion accidents of the gas vehicle and provides safe driving.

On the other hand, a hydrogen fuel cell vehicle being currently developed has a high hydrogen pressure in the range between 300 mba and 350 mba and also has 6 times higher in hydrogen diffusion speed than that of natural gas and 2.7 times higher than that of helium, so that it is hard to sense the outside of the pressure-resistant container and it is easy to sense hydrogen in a closed casing. Especially, if 4% hydrogen gas exists in the air, explosion may occur.

Furthermore, gas leakage may frequently occur from a discharge valve of the pressure-resistant container. Accordingly, there is an urgent need for the development of a method that senses the gas leakage from the discharge valve.

### SUMMARY OF THE INVENTION

Accordingly, the present invention has been made in view of the above-mentioned problems occurring in the prior art, and it is an object of the present invention to provide a pressure-resistant container gas leakage detecting device for a vehicle, to which a discharge tube casing is coupled, thereby preventing the explosion of a pressure-resistant container in the vehicle using compressed natural gas or compressed hydrogen gas and providing safe driving of the vehicle.

It is another object of the present invention to provide a pressure-resistant container gas leakage detecting device for a vehicle, to which a discharge tube casing is coupled, wherein even if a small amount of gas leaks, the gas leakage is early detected to basically prevent the occurrence of explosion accidents.

It is still another object of the present invention to provide a pressure-resistant container gas leakage detecting device for a vehicle, to which a discharge tube casing is coupled, wherein even cracks occurring on a pressure-resistant container and a casing can be easily sensed.

It is yet another object of the present invention to provide a pressure-resistant container gas leakage detecting device for a vehicle, to which a discharge tube casing is coupled, wherein no impact is applied to a pressure-resistant container.

It is yet still another object of the present invention, to provide a pressure-resistant container gas leakage detecting device for a vehicle, to which a discharge tube casing is coupled, wherein the gas leakage occurring from a discharge valve of a pressure-resistant container is sensed.

To accomplish the above objects, according to the present invention, there is provided a pressure-resistant container gas leakage detecting device for a vehicle, to which a discharge tube casing is coupled, the pressure-resistant container gas leakage detecting device including: a casing having a first casing member and a second casing member coupled to the first casing member so as to form an internal space; a pressure-resistant container having a body coupled to the interior of the casing and a discharge tube exposed to the outside of the casing, the discharge tube being adapted to introduce gas thereinto and to discharge gas therefrom; the discharge tube casing adapted to cover the discharge tube; a first gas leakage detecting sensor attached to the discharge tube casing; corrosion-preventing gas injected between the pressure-resistant container and the casing in such a manner as to be filled thereinto higher or lower than atmospheric pressure; and a gas pressure detecting sensor coupled to the casing so as to detect the occurrence of the change in the pressure of the corrosion-preventing gas.

According to the present invention, desirably, the pressure-resistant container gas leakage detecting device further includes a second gas leakage detecting sensor coupled to the casing so as to sense the gas leakage from the pressure-resistant container.

### BRIEF DESCRIPTION OF THE DRAWINGS

The above and other objects, features and advantages of the present invention will be apparent from the following detailed description of the preferred embodiments of the invention, in conjunction with the accompanying drawings, in which:

FIG. 1 is a separate perspective view showing a pressure-resistant container gas leakage detecting device for a vehicle, to which a discharge tube casing is coupled, according to the present invention;

FIG. 2 is a sectional view showing the pressure-resistant container gas leakage detecting device for a vehicle, to which a discharge tube casing is coupled, according to the present invention;

FIG. 3 is a sectional view taken along the line A-A′ of FIG. 2;

FIG. 4 is a sectional view taken along the line B-B′ of FIG. 2; and

FIG. 5 is a sectional view taken along the line C-C′ of FIG. 2.

### DESCRIPTION OF THE PREFERRED EMBODIMENT

Hereinafter, an explanation on a pressure-resistant container gas leakage detecting device for a vehicle, to which a discharge tube casing is coupled, according to the present invention will be in detail given with reference to the attached drawing.

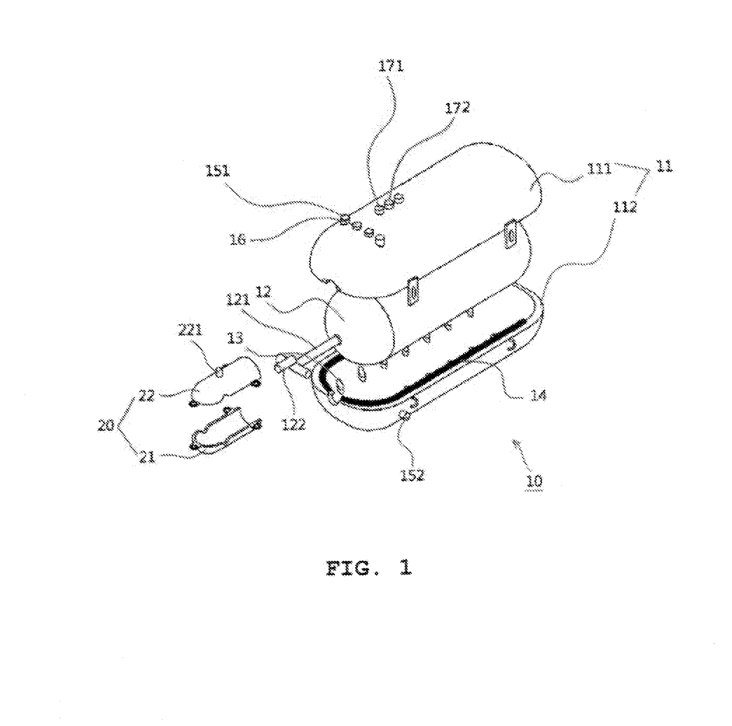

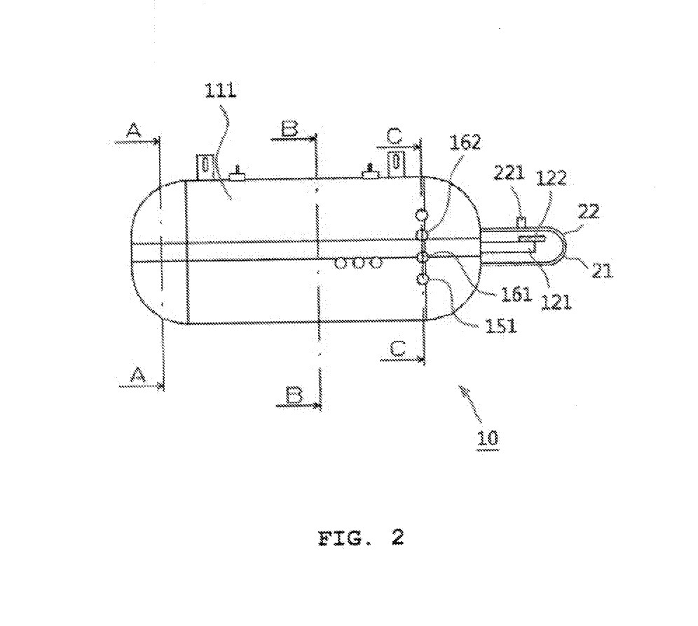

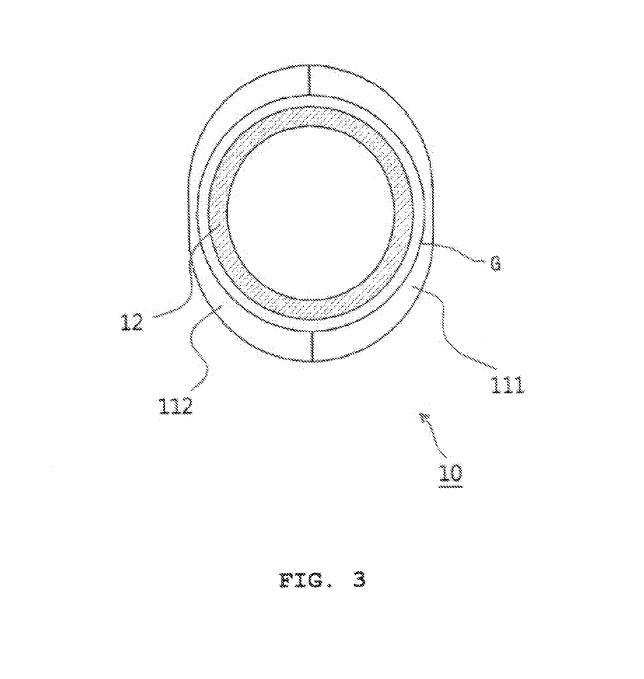

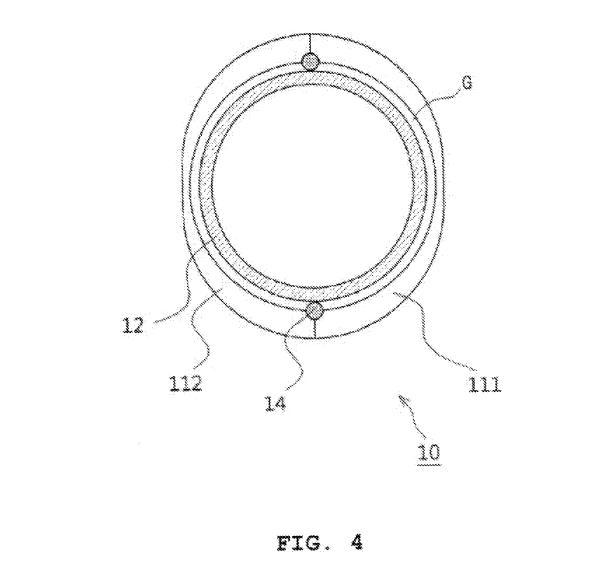

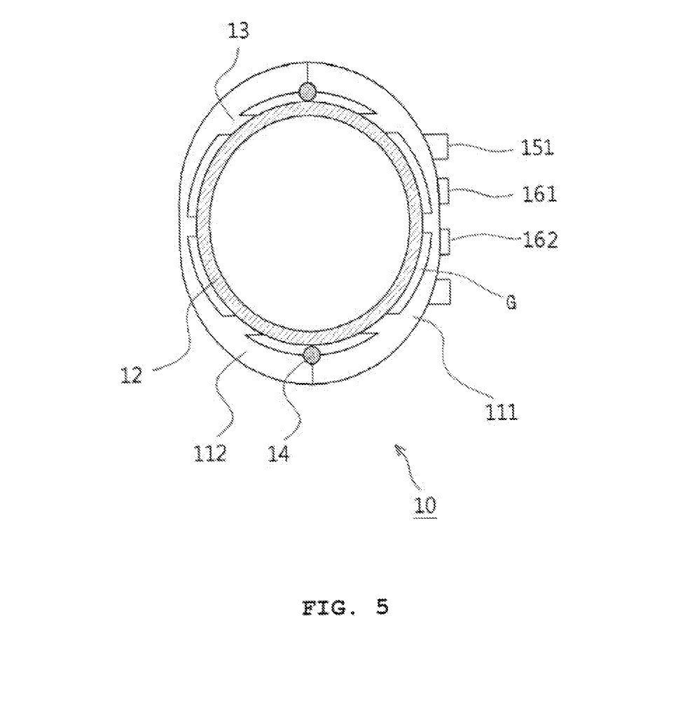

FIG. 1 is a separate perspective view showing a pressure-resistant container gas leakage detecting device tor a vehicle, to which a discharge tube casing is coupled, according to the present invention. FIG. 2 is a sectional view showing the pressure-resistant container gas leakage detecting device for a vehicle, to which a discharge tube casing is coupled, according to the present invention. FIG. 3 is a sectional view taken along the line A-A′ of FIG. 2, FIG. 4 is a sectional view taken along the line B-B′ of FIG. 2, and FIG. 5 is a sectional view taken along the line C-C′ of FIG. 2.

According to the present invention, there is provided a pressure-resistant container gas leakage detecting device 10 for a vehicle, to which a discharge tube casing 20 is coupled, the gas leakage detecting device 10 including: a casing 11 having a first casing member 111 and a second casing member 112 coupled to the first casing member 111 so as to form an internal space; corrosion-preventing gas G injected between the pressure-resistant container 12 and the casing 11 in such a manner as to be filled thereinto higher or lower than atmospheric pressure; and a gas pressure detecting sensor 161 coupled to the casing 11 so as to detect the occurrence of the change in the pressure of the corrosion-preventing gas G.

The casing 11 includes the first casing member 111 and the second casing member 112. If the first casing member 111 and the second casing member 112 are fittedly coupled to each other, the internal space is formed between the first casing member 111 and the second casing member 112. A body of the pressure-resistant container 12 is mounted in the internal space formed by the first casing member 111 and the second casing 112. A discharge tube 121 of the pressure-resistant container 12 is protruded outwardly from the internal space.

The casing 11 is made of a metal material like a stainless steel. According to the present invention, the first casing member 111 and the second casing member 112 are symmetrically formed with respect to each other. Further, the first casing member 111 has a cap-like shape, and the second casing member 112 has a cap covering the top surface of the cup-like first casing member 111.

Sealing members may be mounted along the coupled portions between the first casing member 111 and the second casing member 112.

The pressure-resistant container 12 is disposed in the internal space formed by coupling the first casing member 111 and the second casing member 112. The pressure-resistant container 12 is a container into which compressed natural gas is stored.

The corrosion-preventing gas G is stored into the space between the casing 11 and the pressure-resistant container 12. The corrosion-preventing gas G is gas like nitrogen that has no reactivity. Preferably, the corrosion-preventing gas G is filled higher than atmospheric pressure, but it may be filled lower than atmospheric pressure.

The gas pressure detecting sensor 161 is coupled to the casing 11 and detects the internal pressure of the casing 11. If the detected pressure is over a reference pressure, a pressure alarm 171 is operated.

If cracks occur on the pressure-resistant container 12, high pressure compressed natural gas leaks, which increases the internal pressure of the casing 11. In this case, the gas pressure detecting sensor 161 senses the gas leakage to allow the pressure alarm 171 to be operated, and the pressure alarm 171 generates red warning light or sound.

On the other hand, if cracks occur on the casing 11, the internal air of the casing 11 leaks outside or the external air enters the casing 11, so that the internal pressure of the casing 11 is almost equal to the atmospheric pressure.

At this time, the gas pressure detecting sensor 161 senses the leakage of the casing 11 to allow the pressure alarm 171 to be operated, and the pressure alarm 171 generates green warning light or sound.

Through the recognition of the warning light or sound generated from the pressure alarm 171, accordingly, a vehicle manager can check whether the cracks occur on the pressure-resistant container 12 or on the casing 11 and can exchange it with new one.

On the other hand, a gas leakage detecting sensor 162 is coupled to the casing 11.

The gas leakage detecting sensor 162 senses whether the compressed natural gas leaks or not from the internal space of the casing 11. That is, if gas leakage occurs by means of the formation of the cracks on the pressure-resistant container 12, the compressed natural gas remains inside the closed casing 11, and the leakage of the compressed natural gas is sensed by the gas leakage detecting sensor 162. Even if a small amount of compressed natural gas leaks, it is collected inside the casing 11, and accordingly, the leakage of the compressed natural gas is sensed by the gas leakage detecting sensor 162.

The pressure-resistant container 12 is exposed to the outside in the conventional practice, and therefore, even if gas leakage occurs, it is hard to detect the gas leakage through a gas leakage detecting sensor. According to the present invention, however, the gas leaking from the pressure-resistant container 12 exists inside the casing 11, so that even if a small amount of gas leaks, it can be easily detected through the gas leakage detecting sensor 162.

If the gas leakage is sensed through the gas leakage detecting sensor 162, a gas alarm 172 is operated.

The casing 11 has a plurality of buffering protrusions 13 formed on the inner peripheral wall thereof so as to prevent the outer peripheral wall of the pressure-resistant container 12 from being contacted with the inner peripheral wall of the casing 11. The buffering protrusions 13 are made of a synthetic material having good elasticity.

On the other band, a shielding member 14 is interposed to a shape of a band between the inner peripheral wall of the casing 11 and the outer peripheral wall of the pressure-resistant container 12. The shielding member 14 blocks the internal space between the first casing member 111 and the second casing member 112, while a portion thereof is being open, as shown in FIG. 3. Through the open portion of the shielding member 14, air flows. A test gas introduction tube 151 is formed on the first casing member 111, and a test gas discharge tube 152 is formed on the second casing member 112. Further, a safety value (not shown) is mounted on the test gas discharge tube 152.

It should be periodically checked whether the gas leakage detecting sensor 162 is correctly operated or not. Accordingly, the test gas (for example, the compressed natural gas CNG) is injected into the casing 11 through the test gas introduction tube 151. After testing, the test gas should be discharged to the outside. At this time, if the internal space of the casing 11 is not compartmented like a maze, the test gas remains at the interior of the casing 11, and in this case, the remaining test gas makes the gas leakage detecting sensor 162 erroneously operated.

According to the present invention, the gas leakage detecting device 10 is provided with the casing 11, and accordingly, even if it is mounted on the underside of the vehicle, the pressure-resistant container 12 can be protected from external environments. Furthermore, even though a substantially small amount of gas leaks from the pressure-resistant container 12, the gas exists in the space between the pressure-resistant container 12 and the casing 11, so that the gas leakage can be easily detected by means of the gas leakage detecting sensor 162.

Further, the internal space between the pressure-resistant container 12 and the casing 11 is compartmented like a maze by means of the shielding member 14, so that after the test gas is injected, it can be easily discharged to the outside.

FIG. 4 is a sectional slew taken along the line B-B′ of FIG. 2, and FIG. 5 is a sectional view taken along the line C-C′ of FIG. 2. Referring to FIGS. 4 and 5, the inner peripheral wall of the casing 11 and the outer peripheral wall of the pressure-resistant container 12 of the gas leakage detecting device 10 are blocked by means of the shielding member 14. To the contrary, referring to FIG. 3, the shielding member 14 is not interposed between the inner peripheral wall of the casing 11 and the outer peripheral wall of the pressure-resistant container 12, so that air flows gently to the space between the pressure-resistant container 12 and the casing 11. As a result, the test gas introduced through the test gas introduction tube 151 is passed through the area in FIG. 3 and moved and discharged through the test gas discharge tube 152. When the test gas introduction tube 151 and the test gas discharge tube 152 are disposed on one side of the casing 11, it is convenient to inject and discharge the test gas into and from the casing 11.

On the other hand, gas leakage accidents frequently occur on a discharge valve 122 of the discharge tube 121. Accordingly, it should be sensed whether gas leaks from the discharge valve 122. The discharge tube 121 is coupled to the discharge tube casing 20 covering the discharge tube 121 and the discharge valve 122.

The discharge tube casing 20 is formed of a pair of casing members coupled to each other. The pair of casing members is fastened to each other by means of bolts and nuts. The discharge tube casing 20 is coupled to a gas leakage detecting sensor 221. The gas leakage detecting sensor 221 senses the gas leakage occurring from the interior of the discharge tube casing 20 and generates the sensed result as a warning signal to the outside.

The warning signal becomes a warning sound or light.

The present invention is applicable to an automobile industrial field and all kinds of industrial fields wherein gas is stored and used.

As set forth in the foregoing, the pressure-resistant container gas leakage detecting device for a vehicle according to the present invention can protect the pressure-resistant container from external impacts and environments and early detect a small amount of gas leaking.

Further, the pressure-resistant container gas leakage detecting device for a vehicle according to the present invention can prevent the pressure-resistant container from being corroded.

Furthermore, the pressure-resistant container gas leakage detecting device for a vehicle according to the present invention can early detect the damage of the casing.

Additionally, the pressure-resistant container gas leakage detecting device for a vehicle according to the present invention can keep the pressure-resistant container in a safer manner through the prevention of the corrosion of the pressure-resistant container.

Moreover, the pressure-resistant container gas leakage detecting device for a vehicle according to the present invention can easily detect the cracks occurring on the pressure-resistant container and casing.

Further, the pressure-resistant container gas leakage detecting device for a vehicle according to the present invention can prevent external impacts from being applied to the pressure-resistant container.

Further, the pressure-resistant container gas leakage detecting device for a vehicle according to the present invention can detect the gas leakage occurring from the discharge valve of the pressure-resistant container.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A pressure-resistant container gas leakage detecting device for a vehicle, to which a discharge tube casing is coupled, the device comprising:
a casing having a first casing member and a second casing member coupled to the first casing member so as to form an internal space;
a pressure-resistant container having a body coupled to the interior of the casing and a discharge tube exposed to the outside of the casing, the discharge tube being adapted to introduce gas thereinto and to discharge gas therefrom;
the discharge tube casing adapted to cover the discharge tube;
a first gas leakage detecting sensor attached to the discharge tube casing;
corrosion-preventing gas injected between the pressure-resistant container and the casing in such a manner as to be filled thereinto higher or lower than atmospheric pressure; and
a gas pressure detecting sensor coupled to the casing so as to detect the occurrence of the change in the pressure of the corrosion-preventing gas.

2. The pressure-resistant container gas leakage detecting device according to claim 1, further comprising a second gas leakage detecting sensor coupled to the casing so as to sense the gas leakage of the pressure-resistant container.

3. A pressure-resistant container gas leakage detecting device for a vehicle, the device comprising:
a casing having a first casing member and a second casing member coupled to the first casing member so as to form an internal space;
a pressure-resistant container having a body coupled to the interior of the casing and a discharge tube exposed to the outside of the casing, the discharge tube being adapted to introduce gas thereinto and to discharge gas therefrom; and
a gas pressure detecting sensor coupled to the casing so as to detect whether gas leaking from the pressure-resistant container exists in the interior of the casing.

4. The pressure-resistant container gas leakage detecting device according to claim 3, further comprising:
a shielding member interposed to a shape of a band between the inner peripheral wall of the casing and the outer peripheral wall of the pressure-resistant container, so as to block the internal apace between the first casing member and the second casing member, while a portion thereof is being open;
a test gas introduction tube formed on the first casing member; and
a test gas discharge tube formed on the second casing member.

5. The pressure-resistant container gas leakage detecting device according to claim 4, wherein the test gas discharge tube is coupled to a safety valve.
